(19) United States
(12) Patent Application Publication
(10) Pub. No.: US 2007/0077488 A1
(43) Pub. Date: Apr. 5, 2007

(54) Power capability of a cathode

(76) Inventors: Kaimin Chen, New Brighton, MN (US); Craig L. Schmidt, Eagan, MN (US)

Correspondence Address: MEDTRONIC, INC., 710 MEDTRONIC PARK, MINNEAPOLIS, MN, 55432-9924, US

(21) Appl. No.: 11/343,887

(22) Filed: Jan. 31, 2006

Related U.S. Application Data
(60) Provisional application No. 60/723,334, filed on Oct. 4, 2005.

(51) Int. Cl. H01M 4/02; H01M 4/54; H01M 4/58; H01M 4/48

(52) U.S. Cl. 429/209; 429/219; 429/231.5; 429/231.7; 429/231.2; 429/224; 429/220

(57) ABSTRACT

An electrochemical cell is presented. The electrochemical cell includes an anode, a separator, and a cathode. The separator is coupled to the anode and to the cathode. The cathode comprises a first layer, a second layer, and a single current collector. The first layer includes a first surface and a second surface. A second layer, less than 2 mils thick, is introduced over the first surface of the first layer without a current collector being disposed between the first and the second layers. The current collector is coupled to the second surface of the first layer.

### FIELD OF THE INVENTION

The present invention relates generally to an electrochemical cell and, more particularly, to a cathode.

### BACKGROUND OF THE INVENTION

Implantable medical devices (IMDs) detect and deliver therapy to address a variety of medical conditions in patients. Exemplary IMDs include implantable pulse generators (IPGs) or implantable cardioverter-defibrillators (ICDs) that deliver electrical stimulation to tissue of a patient. ICDs typically include, inter alia, a control module, a capacitor, and a battery that are housed in a hermetically sealed container. When therapy is required by a patient, the control module signals the battery to charge the capacitor, which in turn discharges electrical stimuli to tissue of a patient.

IMDs are continuously improved to offer features related to therapy delivery. To ensure sufficient power exists to support these features, battery designers seek increased power and maintenance of packaging efficiency while decreasing the cost of manufacturing batteries. It is therefore desirable to develop an electrochemical cell that achieves these criteria.

### BRIEF DESCRIPTION OF THE DRAWINGS

The present invention will become more fully understood from the detailed description and the accompanying drawings, wherein:

FIG. 1 is a perspective view of an exemplary electrochemical cell;

FIG. 2A is a cross-sectional view of a first layer of a cathode;

FIG. 2B is a cross-sectional view of a second layer introduced over the first layer of the cathode depicted in FIG. 2A;

FIG. 2C is a cross-sectional view of a current collector coupled to the cathode depicted in FIG. 2B;

FIG. 3A is a cross-sectional view of a multilayer form of a cathode;

FIG. 3B is a cross-sectional view of a cathode formed that includes introduction of second layers over first layers of the cathode depicted in FIG. 3A;

FIG. 4 is a graph that depicts voltage and depth of discharge for an exemplary electrochemical cell compared to a conventional electrochemical cell;

FIG. 5 is another graph that depicts voltage and depth of discharge for an exemplary electrochemical cell compared to a conventional electrochemical cell; and

FIG. 6 is a flow diagram that depicts a process for forming an exemplary cathode.

### DETAILED DESCRIPTION OF THE EMBODIMENTS

The following description of an embodiment is merely exemplary in nature and is in no way intended to limit the invention, its application, or uses. For purposes of clarity, the same reference numbers are used in the drawings to identify similar elements.

The present invention is directed to an electrochemical cell (e.g. battery) that includes an anode, a separator, and a cathode. The separator is coupled to the anode and to the cathode. The cathode comprises a first layer, a second layer, and a single current collector. The first layer includes a first surface and a second surface. A second layer, less than 2 mils thick, is introduced over the first surface of the first layer without a current collector being disposed between the first and second layers. A current collector is coupled to the second surface of the first layer.

The present invention increases power capability, maintains energy density and reduces costs associated with production of a battery. For example, a current collector is eliminated between the first and the second layers of the cathode. Therefore, the cost of the current collector itself and the labor cost associated with introducing the current collector to a cathode is eliminated.

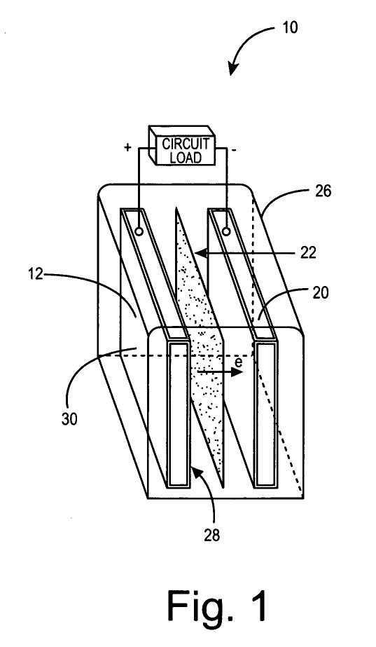

FIG. 1 depicts an exemplary electrochemical cell 10 such as a battery. A detailed example of such a configuration may be seen with respect to U.S. Pat. No. 5,180,642 issued to Weiss et al. and U.S. Pat. No. 5,766,797 issued to Crespi et al., and assigned to the assignee of the present invention, the disclosures of which are incorporated by reference, in relevant parts. Electrochemical cell 10 generally includes an anode 20, a separator 22, and a cathode 12 disposed within housing 26. Cathode 12 includes first and second surfaces 28, 30. In one embodiment, cathode 12 is a hybrid cathode. A hybrid cathode involves a mixture of carbon monofluoride (CFx) and silver vanadium oxide (SVO). In another embodiment, cathode 12 is a non-hybrid cathode. An exemplary non-hybrid cathode includes a layer of SVO over a layer of CFx. Hybrid and nonhybrid cathodes also include other material such as conductive carbon and binder.

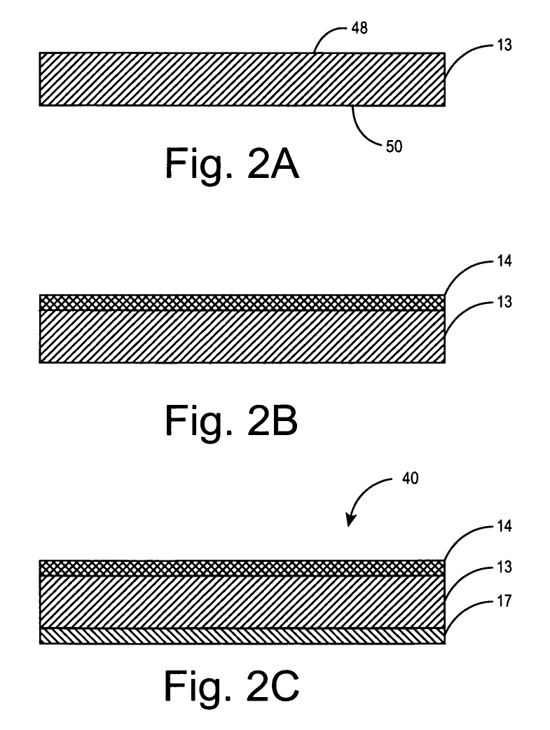

FIGS. 2A-2C depict formation of a single side or half of cathode 40. FIG. 2A shows a first layer 13 of cathode 40. In one embodiment, first layer 13 is made of CFx and SVO. In another embodiment, first layer 13 comprises solely CFx as the active material. In still yet another embodiment, first layer 13 comprises, in varying percentages, at least SVO (Ag₂V₄O₁₁), CFx/SVO, CFx and other metal oxides such as manganese oxide (MnO2), vanadium oxide (V₂O₅), lithium vanadium oxide (LiV₃O₈), and copper vanadium oxide (Cu₂V₄O₁₁).

After first layer 13 is properly formed and positioned in a die (not shown), a thin second layer 14 or coating is introduced over a first surface 48 of a first layer 13 of cathode 40, as shown in FIG. 2B. In one embodiment, second layer 14 comprises at least one of SVO, CFx/SVO, CFx alone, or CFx with other metal oxides (e.g. MnO₂, V₂O₅, lithium vanadium oxide (e.g. LiV₃O₈), and copper vanadium oxide (e.g. Cu₂V₄O₁₁)). In another embodiment, second layer 14 comprises SVO in the range of about 70% to 100%. The remaining portion of second layer 14 comprises conductive carbon and binder in an amount that is equal to or less than 30%. Various processes may be used to introduce second layer 14 over first layer 13. Exemplary processes include powder sprinkling, powder spraying, slurry coating, extrusion or dipping of first layer 13 to form second layer 14. Typically, material for second layer 14 is in the form of a powder, which is sprinkled over first layer 13. Alternatively, a piece of material is cut from a sheet of material formed from an extrusion process. The piece of material is then pressed onto the first surface 28 of first layer 13.

The thickness of second layer 14 (e.g. SVO layer) can be 2 mils or less. In an alternate embodiment, the second layer 14 is 1 mils or less.

FIG. 2C illustrates formation of a single side or half of cathode 40. Here, a current collector 17 is coupled to a second surface 50 of first layer 13. Current collector 17 is a flat grid or foil that conducts current from or to an electrode during discharge or charging. In another embodiment, if current collector 17 is a cup collector, then the resultant product is a fully formed and functional cathode such as cathode 12. The power capability of cathode 12, particularly in the first half of discharge, is enhanced by second layer 14.

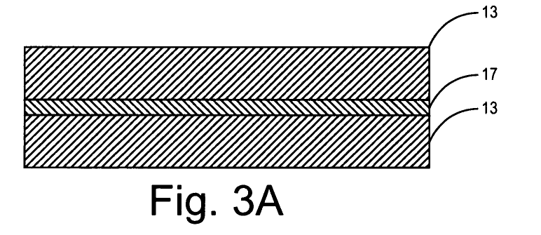

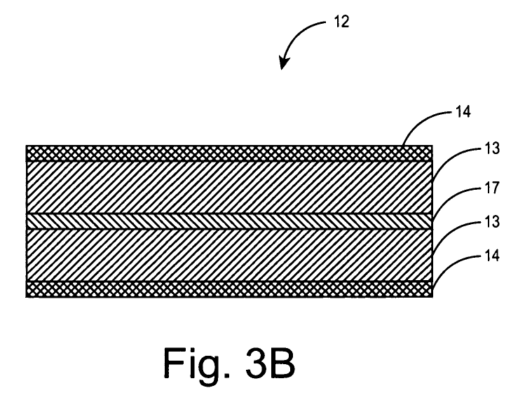

FIGS. 3A-3B depict formation of cathode 12. For example, material for first layers 13 is placed into a die (not shown) and current collector 17 is pressed into first layers 13. Thereafter, second layers 14 are pressed onto first layers 13 via the methods previously discussed. As shown, cathode 12 may comprise two first layers 13 and two second layers 14. In this embodiment, a dramatic cost savings is realized since current collectors are not present between each first and second layers 13, 14 respectively.

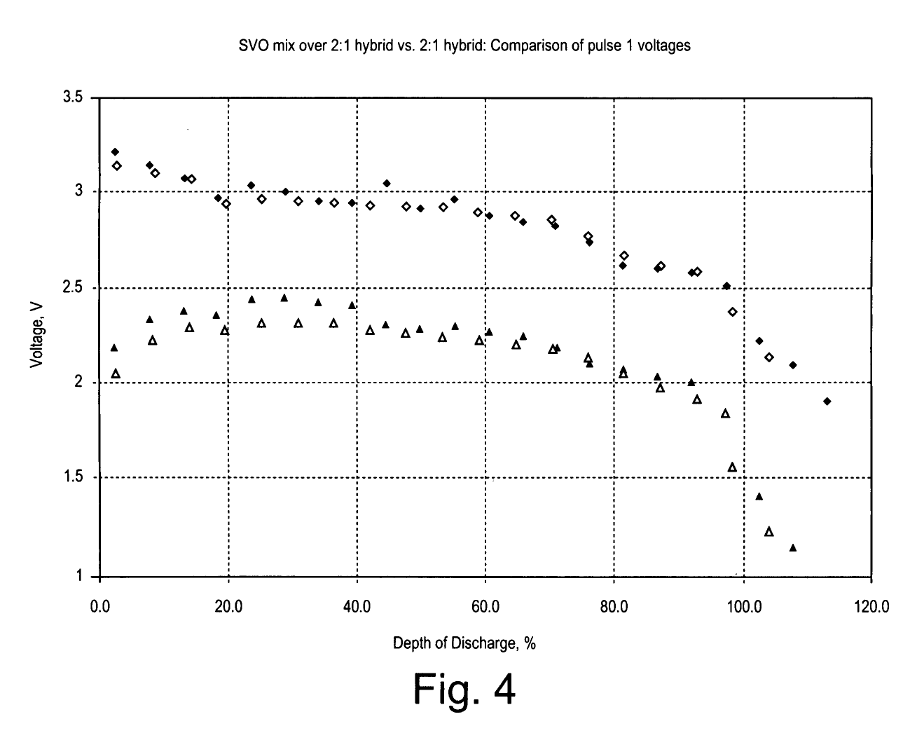

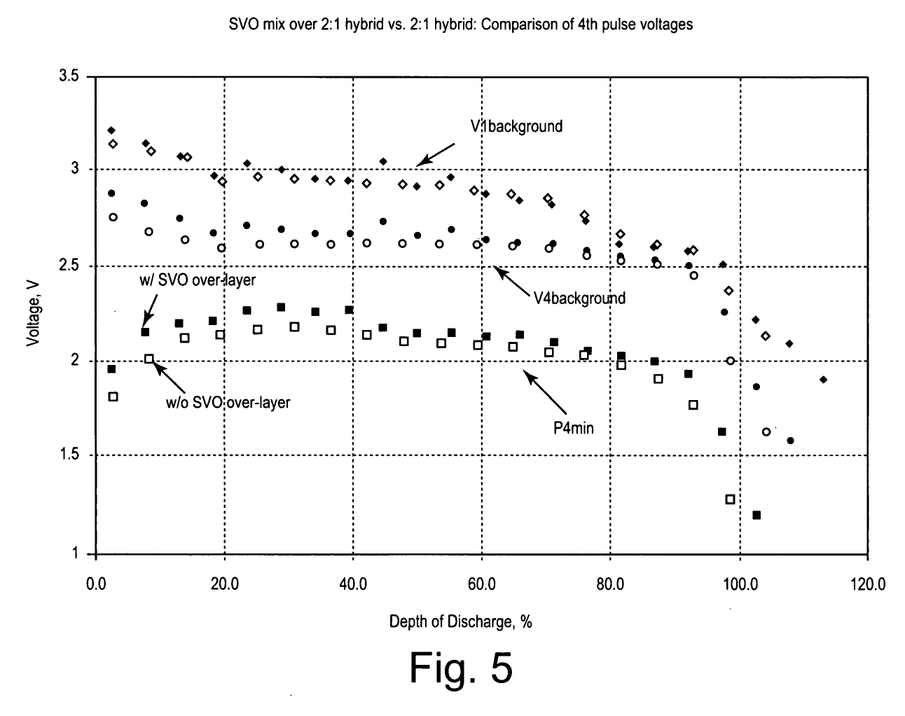

FIGS. 4 and 5 graphically compare voltage in a cathode 12 that includes second layer 14 versus a cathode without second layer 14. In this embodiment, cathode 12 is a hybrid cathode with second layer 14 comprising SVO. A background voltage (V₁) 100 serves as a reference to establish the state of the cathode in electrochemical cell 10. Cathode 12 exhibits a voltage 120, which is higher, from the beginning of life (BOL) through at least 40% or more of depth of discharge, than the voltage 130 of a cathode without a second layer 14. The minimum pulse voltages (first pulse, P1) 140 are shown in FIG. 1 and (fourth pulse, P4) 142 shown in FIG. 2.

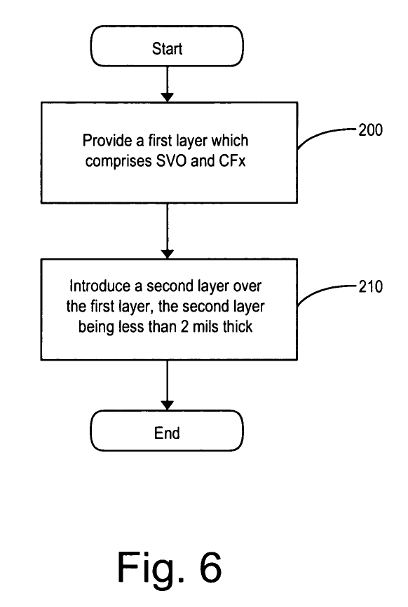

FIG. 6 is a flow diagram that depicts a process for forming an exemplary cathode. At block 200, a first layer which comprises SVO and CFx is provided. At block 210, a second layer is introduced over the first layer. The second layer comprises at least one of SVO, CFx/SVO, CFx alone, CFx and a metal oxide. The second layer is less than about 1 mils thick.

The present invention has numerous applications. For example, while the description relates to a high power—low energy density over low power—high energy density, the present invention encompasses low power over high energy density to improves the quality of cathode 12. Additionally, the present invention includes two or more different compositions of the same materials (e.g. two different CFx/SVO ratios etc.). Moreover, high power material on the surface is configured to include some degree of rechargeability referred to as this “microrechargeability.” Microrechargeability relates to charging of the high power material by the low power material (e.g. charging of second layer 14 by first layer 13) when therapy is not required. Therefore, the power availability of the high power material is maintained.

The following patent applications are incorporated by reference in their entirety. Co-pending U.S. patent application Ser. No. ______, entitled “RESISTANCE-STABILIZING ADDITIVES FOR ELECTROLYTE”, filed by Donald Merritt and Craig Schmidt and assigned to the same Assignee of the present invention, describes resistance-stabilizing additives for electrolyte. Co-pending U.S. patent application Ser. No. ______, entitled “ELECTROLYTE ADDITIVE FOR PERFORMANCE STABILITY OF BATTERIES”, filed by Kevin Chen, Donald Merritt and Craig Schmidt and assigned to the same Assignee of the present invention, describes resistance-stabilizing additives for electrolyte.

The description of the invention is merely exemplary in nature and, thus, variations that do not depart from the gist of the invention are intended to be within the scope of the invention. Such variations are not to be regarded as a departure from the spirit and scope of the invention.

1. An electrochemical cell comprising:
an anode;
a separator coupled to the anode;
a cathode coupled to the separator, the cathode includes a first layer having a first surface and a second surface; and
a second layer over the first surface of the cathode, without a current collector being disposed between the first and second layers.

2. The electrochemical cell of claim 1 wherein the second layer comprises one of silver vanadium oxide (SVO), carbon monoflouride (CFx)/SVO, CFx alone, CFx and a metal oxide.

3. The electrochemical cell of claim 1, wherein the second layer has a thickness less than about 2 mils.

4. The electrochemical cell of claim 1, wherein the second layer has a thickness less than about 1 mil.

5. The electrochemical cell of claim 1, wherein the first layer comprises SVO and CFx.

6. A hybrid cathode comprising:
a first layer which includes SVO and CFx; and
a second layer introduced over the first layer, without a current collector being disposed between the first and second layers.

7. The hybrid cathode of claim 6, wherein the first layer comprises SVO.

8. The cathode of claim 6, wherein the second layer includes a thickness less than about 1 mil.

9. A non-hybrid cathode comprising:
a first layer which includes CFx; and
a second layer introduced over the first layer, without a current collector being disposed between the first and second layers.

10. The non-hybrid cathode of claim 9, wherein the second layer comprises SVO.

11. A hybrid cathode comprising:
a first layer which includes SVO and CFx; and
a second layer introduced over the first layer, without a current collector being disposed between the first and second layers, the second layer comprises at least one of SVO, CFx/SVO, CFx alone, CFx and a metal oxide.

12. The hybrid cathode of claim 11 wherein the metal oxide being one of MnO₂, V₂O₅, lithium vanadium oxide and copper vanadium oxide.

13. The hybrid cathode of claim 11 wherein the second layer being less than 2 mils.

14. The hybrid cathode of claim 11 wherein the second layer being less than about 1 mils.

15. A method for forming a cathode of a battery in an implantable medical device comprising:
providing a first layer which comprises SVO and CFx;
introducing a second layer over the first layer, the second layer comprises at least one of SVO, CFx/SVO, CFx alone, CFx and a metal oxide, the second layer being less than about 1 mils thick.

16. The method of claim 15, wherein a current collector does not exist between the first and second layers.

17. The method of claim 15 further comprising:
forming the second layer via one of powder sprinkling, powder spraying, slurry coating, extrusion and dipping.

18. An electrochemical cell comprising:
an anode;
a separator coupled to the anode;
a cathode coupled to the separator, the cathode includes a first layer having a first surface and a second surface; and
a second layer over the first surface of the cathode, without a current collector being disposed between the first and second layers,
wherein the first layer comprises one of CFx/SVO, CFx, CFx and a metal oxide, the metal oxide selected from a group consisting of manganese oxide (MnO2), vanadium oxide (V₂O₅), lithium vanadium oxide (LiV₃O₈), and copper vanadium oxide (Cu₂V₄O₁₁)
wherein the second layer comprises one of SVO, CFx/SVO, CFx, metal oxides selected from the group consisting of MnO₂, V₂O₅, LiV₃O₈, and Cu₂V₄O₁₁, CFx with at least one metal oxide, the metal oxide selected from the group consisting of MnO₂, V₂O₅, LiV₃O₈, and Cu₂V₄O₁₁.
